(19) United States
(12) Patent Application Publication
(10) Pub. No.: US 2013/0213515 A1
(43) Pub. Date: Aug. 22, 2013

(54) INSULATION MEMBERS EMPLOYING STANDOFF SURFACES FOR INSULATING PIPES, AND RELATED COMPONENTS AND METHODS

(71) Applicant: Joseph Robert Secoura, Wake Forest, NC (US)

(72) Inventor: Joseph Robert Secoura, Wake Forest, NC (US)

(21) Appl. No.: 13/772,866

(22) Filed: Feb. 21, 2013

Related U.S. Application Data
(60) Provisional application No. 61/601,960, filed on Feb. 22, 2012.

(51) Int. Cl. F16L 59/14

(52) U.S. Cl. CPC F16L 59/14
USPC 138/149; 29/527.1

(57) ABSTRACT

Insulation members employing standoff surfaces for insulating pipes are disclosed. Related components and methods are also disclosed. Pipes may be used to transport a substance in a fluid and/or gas form that is temperature sensitive. Unwanted heat transfer through an exterior surface of the pipe may be reduced by mounting insulation members on the pipe. In this regard, in embodiments disclosed herein, an anti-corrosive substance may be applied to the exterior surface of the pipe to prevent corrosion. An inner surface of the insulation members may include one or more standoff surfaces configured to mount the insulation members to the pipe to provide insulation, while minimally disturbing the anti-corrosive substance applied to the exterior surface of the pipe, as a non-limiting example.

### PRIORITY APPLICATION

The present application claims priority to U.S. Provisional Patent Application Ser. No. 61/601,960 filed on Feb. 22, 2012, entitled “Interlocking Multiple Component Mattress. Assembly Encasements,” which is hereby incorporated herein by reference in its entirety.

### RELATED APPLICATION

The present application is related to U.S. Provisional Patent Application Ser. No. 61/646,049 filed on May 11, 2012, entitled “Insulation Products Employing Expansion Joints, and Related Components and Methods,” which is hereby incorporated herein by reference in its entirety.

### FIELD OF DISCLOSURE

The field of the disclosure relates to insulation for pipes that may be used with the transportation of temperature-sensitive liquids such as petroleum, liquid carbon dioxide, or natural gas. The insulation may facilitate the transportation of the liquids through environments promoting corrosion of an exterior surface of the pipe.

### BACKGROUND

Benefits of pipes are their ability to transport very large quantities of liquids from a liquid source to one or more destination points. Pipes may be the transportation method of choice when extremely large quantities of liquids are desired to be moved continuously. The liquids being transported through the pipe may be phase-sensitive meaning that the liquids may change to a solid or vapor within a range of ambient temperatures expected for the environment where the pipe will be located. The liquids transported through the pipe may also be viscosity-sensitive, meaning that the liquids may change viscosity within the range of ambient temperatures.

In this regard, heaters and/or coolers may be placed within the pipe to heat or cool a temperature of the liquid to ensure that the liquid stays within an acceptable temperature range to ensure a proper phase and viscosity during transportation thorough the pipe. An amount of energy needed for operation of the heaters and coolers may be reduced through the application of insulation to an external surface of the pipe. Typical insulations contact the external surface of the pipe when they are mounted to the pipe.

The pipe may be made of materials that are vulnerable to corrosion. The pipe may also be placed in an environment which is corrosive to the pipe and difficult to maintain due to remoteness or for other reasons. In these corrosive environments, anti-corrosion substances may be applied as a film to an outer surface of the pipe as protection from the environment. Protection may only be imparted to the pipe while an anti-corrosive substance covers the external surface of the pipe. Some anti-corrosive substances, for example anti-corrosive gels, may be easily scraped or removed from portions of the external surface leaving these portions exposed to the corrosive environment. Conventional insulations for pipes, such as oil pipelines, contact the external surface scraping or removing the anti-corrosive gels from portions of the pipe. Eventual corrosion at these portions may cause leaks and/or frequent, expensive repairs.

### SUMMARY OF THE DETAILED DESCRIPTION

Embodiments disclosed herein include insulation members employing standoff surfaces for insulating pipes. Related components and methods are also disclosed. Pipes may be used to transport a substance in a fluid and/or gas form that is temperature sensitive. Unwanted heat transfer through an exterior surface of the pipe may be reduced by mounting insulation members on the pipe. In this regard, in embodiments disclosed herein, an anti-corrosive substance may be applied to the exterior surface of the pipe to prevent corrosion. An inner surface of the insulation members may include one or more standoff surfaces configured to mount the insulation members to the pipe to provide insulation while minimally disturbing the anti-corrosive substance applied to the exterior surface of the pipe, as a non-limiting example.

In this regard, in one embodiment, an insulation member for a pipe is provided. The insulation member comprises a foam insulation body comprised of at least one foam portion. The foam insulation body is configured to be disposed around a pipe. The foam insulation body comprises at least one foam portion. The at least one foam portion comprises an inner surface configured to face the pipe, and an outer surface opposite the inner surface, the inner surface including at least one foam segment. The at least one foam segment comprises at least one standoff segment configured to abut against the pipe and at least one non-standoff segments configured to be free from abutment against the pipe when the foam insulation body is disposed around the pipe. In this manner, as a non-limiting example, the standoff surfaces are configured to mount the insulation members to the pipe to provide insulation while minimally disturbing the anti-corrosive substance applied to the exterior surface of the pipe.

In another embodiment, a method of forming an insulation member for a pipe is provided. The method comprises extruding at least one foam portion comprising an outer surface and an inner surface configured to face a pipe to form a foam insulation body. The inner surface includes at least one foam segment, the at least one foam segment each comprising at least one standoff segment configured to abut against the pipe and at least one non-standoff segment configured to be free from abutment against the pipe when the foam insulation body is disposed around the pipe. The method also comprises cutting a first side of the foam insulation body. The method also comprises cutting a second side of the foam insulation body, the second side opposite the first side. The method also comprises disposing the foam insulation body around the pipe such that the at least one standoff segment abuts against an exterior surface of the pipe, and the at least one non-standoff segment is free from abutment against the exterior surface of the pipe. The method also comprises securing the first side of the foam insulation body to the second side of the foam insulation body to secure the foam insulation body to the pipe.

### BRIEF DESCRIPTION OF FIGURES

FIGS. 1 and 2 are perspective and longitudinal side views, respectively, of a first embodiment of an insulation member employing standoff surfaces, the insulation member surrounding a pipe to insulate the pipe;

FIGS. 3A and 3B are side and close-up side views, respectively, of the insulation member of FIG. 1 illustrating standoff segments and non-standoff segments;

FIG. 4A is a perspective view of the insulation member of FIG. 1 being wrapped around the pipe of FIG. 1;

FIG. 4B is a perspective view of a second insulation member employing standoff surfaces being attached to a section of the pipe adjacent to the first insulation member of FIG. 1;

FIG. 5 is a flowchart diagram illustrating an exemplary process to manufacture and install the insulation member of FIG. 1 onto a pipe;

FIGS. 6A and 6B are perspective and longitudinal side views, respectively, of a second exemplary embodiment of an insulation member employing standoff surfaces surrounding a pipe to insulate the pipe;

FIG. 7 is a perspective cutaway side view of the insulation member of FIGS. 6A and 6B;

FIG. 8 is a perspective view of an inner surface of the insulation member of FIGS. 6A and 6B;

FIG. 9 is a side view of a foam portion of the insulation member of FIG. 8;

FIG. 10A is a perspective view of the insulation member of FIGS. 6A and 6B being wrapped around a pipe;

FIG. 10B is a perspective view of a second insulation member being attached to the pipe adjacent to the insulation member of FIGS. 6A and 6B;

FIG. 11 is a flowchart diagram illustrating an exemplary process to manufacture and install the insulation member of FIGS. 6A and 6B onto a pipe;

FIGS. 12A and 12B are side and side cross-sectional perspective views, respectively of a third exemplary insulation member employing standoff surfaces for insulating a pipe; and

FIG. 13 is a perspective view of an exemplary spiral forming system for forming an insulation member according to embodiments disclosed herein.

### DETAILED DESCRIPTION

Reference will now be made in detail to the embodiments, examples of which are illustrated in the accompanying drawings, in which some, but not all embodiments are shown. Indeed, the concepts may be embodied in many different forms and should not be construed as limiting herein; rather, these embodiments are provided so that this disclosure will satisfy applicable legal requirements. Whenever possible, like reference numbers will be used to refer to like components or parts.

Embodiments disclosed herein include insulation members employing standoff surfaces for insulating pipes. Related components and methods are also disclosed. Pipes may be used to transport a substance in a fluid and/or gas form that is temperature sensitive. Unwanted heat transfer through an exterior surface of the pipe may be reduced by mounting insulation members on the pipe. In this regard, in embodiments disclosed herein, an anti-corrosive substance may be applied to the exterior surface of the pipe to prevent corrosion. An inner surface of the insulation members may include one or more standoff surfaces configured to mount the insulation members to the pipe to provide insulation while minimally disturbing the anti-corrosive substance applied to the exterior surface of the pipe, as a non-limiting example.

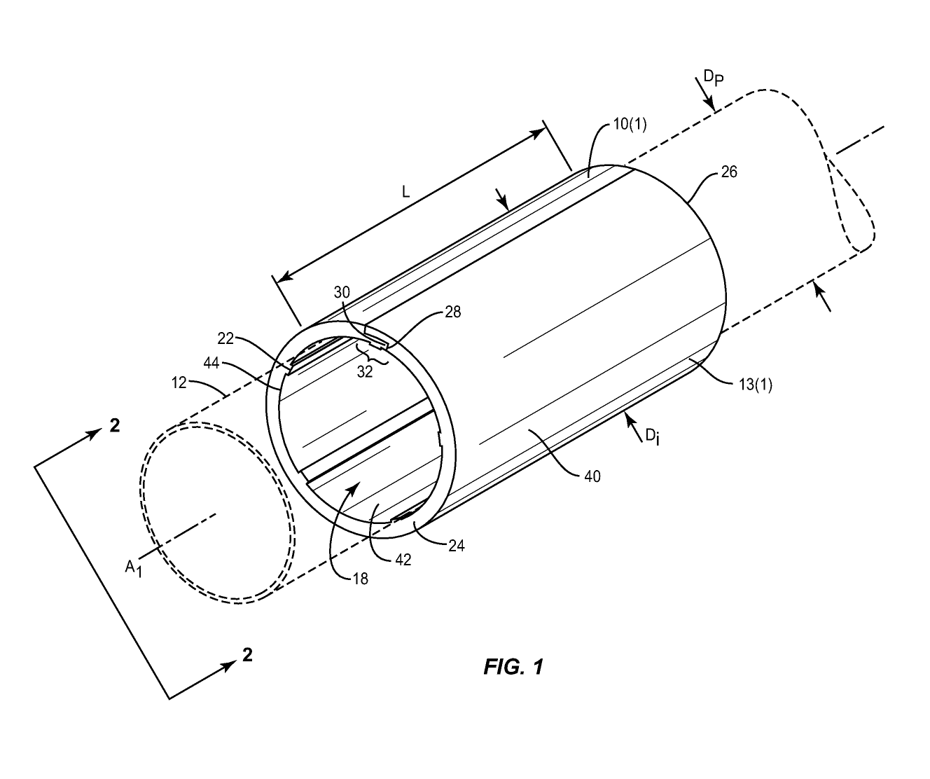

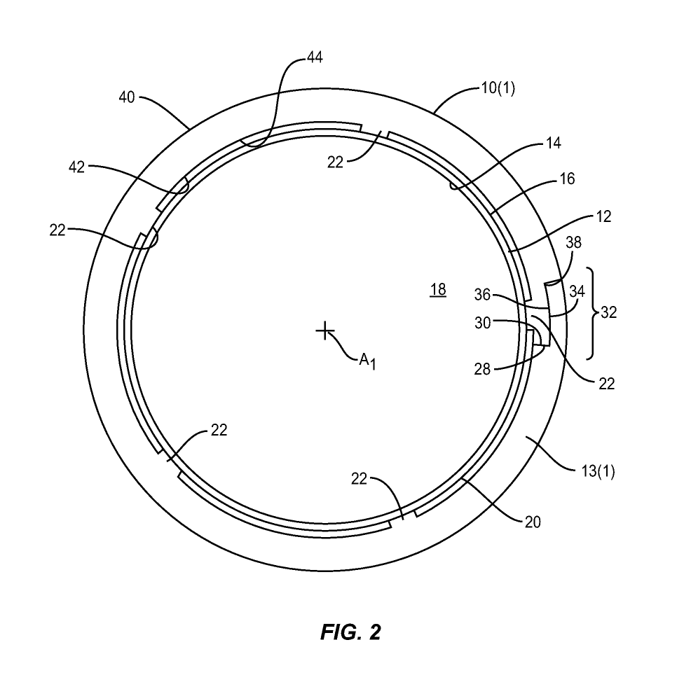

In this regard, FIGS. 1 and 2 are perspective and longitudinal side views, respectively, of a first embodiment of an insulation member 10(1) employing standoff surfaces for insulating a pipe. The insulation member 10(1) is shown installed upon and insulating a pipe 12. For example, the pipe 12 may be an oil pipeline carrying crude oil through an environment having a low temperature, for example, negative thirty (−30) degrees Fahrenheit. The crude oil may be at a temperature greater than one hundred forty (140) degrees Fahrenheit to reduce plugging of the crude oil flow due to wax deposition as a temperature of the inner surface 14 of the pipe 12 decreases below a critical temperature.

With continued reference to FIGS. 1 and 2, the pipe 12 may have a diameter D_{P} and include the inner surface 14 and the exterior surface 16. The inner surface 14 may form an inner space 18 where a substance, for example crude oil, may flow. The pipe 12 may include a longitudinal axis A₁, which may be a center axis of the pipe 12. The pipe 12 may include a cylindrical cross section and may be for example, a steel pipe susceptible to corrosion through exposure to moisture. An anti-corrosive substance 20 may be applied to the exterior surface 16 of the pipe 12 to prevent corrosion. The anti-corrosive substance 20 may be, for example, ReactiveGel® or RG-2400® made by Polyguard of Ennis, Tex. The anti-corrosive substance 20 may cure, harden, or assume a gel form which is susceptible to being scraped or rubbed off.

Unplugging blockages within the pipe 12 can be expensive. The pipeline loses value if crude oil does not flow. Further, frequent unplugging (sometimes called “pigging”) may be expensive in regards to man hours expended and equipment costs. Keeping the pipe 12 above a critical temperature through the use of an insulation member 10(1) and heating equipment (not shown) may prevent plugs in the crude oil in the pipe 12.

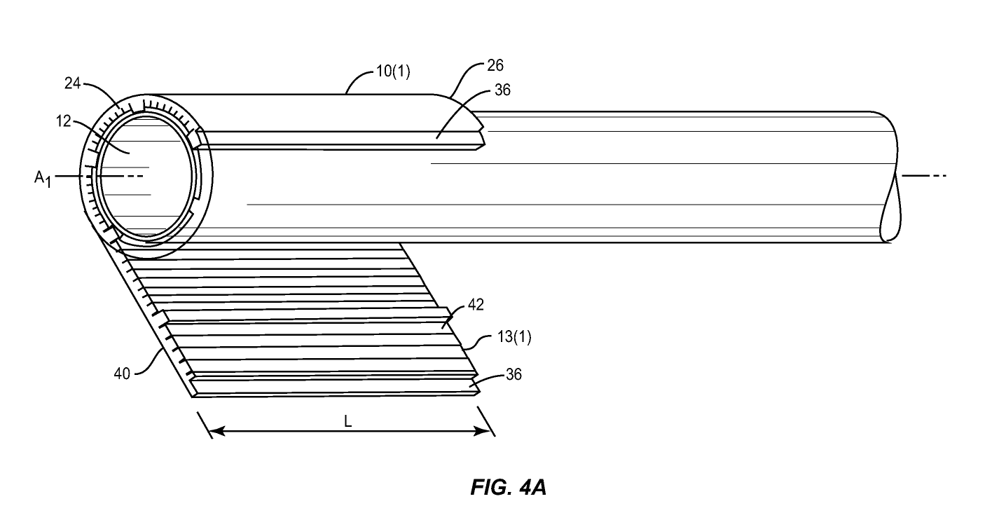

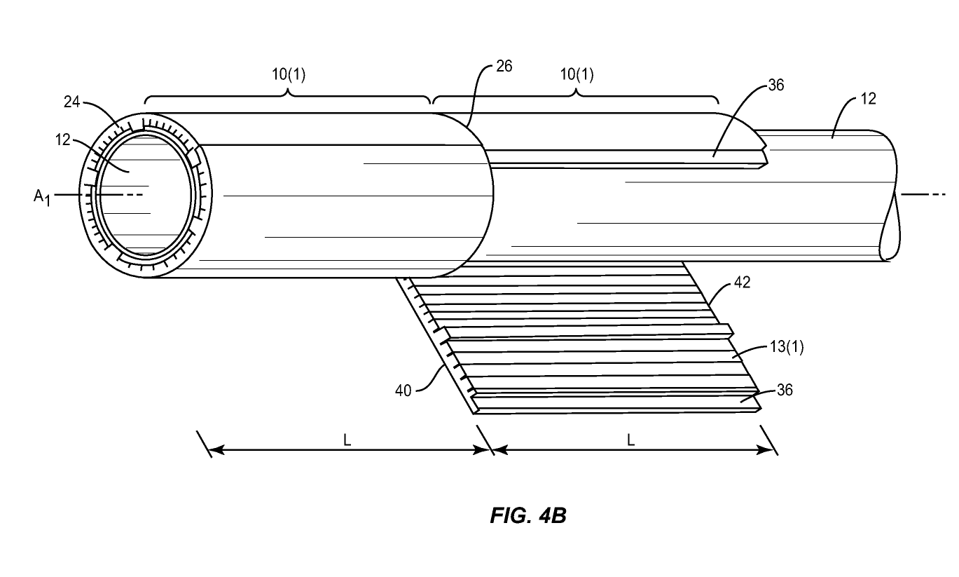

In this regard, the pipe 12 in FIGS. 1 and 2 is filled with the insulation member 10(1) employing at least one standoff surface 22 to reduce disturbance of the anti-corrosive substance 20 applied to the pipe 12, as one non-limiting example. The insulation member 10(1) comprises an elongated foam insulating body 13(1) that may have a length L₁ and may be configured to be wrapped around a length L₁ of the pipe 12(1). The insulation member 10(1) may include a first side 24 and a second side 26. The first side 24 and second side 26 may be separated by the length L₁. The first side 24 and the second side 26 of the insulation member 10(1) may be configured to abut against another insulation member 10(1) as discussed later (see FIG. 4B). The insulation member 10(1) may also include a first end surface 28 and a second end surface 30. The first end surface 28 and the second end surface 30 may be attached by a shiplap connection 32. The shiplap connection 32 may include an outward facing surface 34 and an inward facing surface 36 which may be attached by attachment means 38. The attachment means 38 may be, for example, an adhesive or mechanical fastener.

With continuing reference to FIGS. 1 and 2, the insulation member 10(1) may be made of a resilient material which does not allow moisture to pass, for example, extruded polyethylene foam. The insulation member 10(1) may contain an outer surface 40 and an inner surface 42. The inner surface 42 may be configured to face the pipe 12. The outer surface 40 may face away from the pipe 12 and may be opposite the inner surface 42. The inner surface 42 of the insulation member 10(1) may include at least one standoff surface 22 and at least one non-standoff surface 44. The standoff surfaces 22 are configured to abut against the exterior surface 16 of the pipe 12. The non-standoff surfaces 44 are configured to be free of abutment with the exterior surface 16 of the pipe 12. In this manner as a non-limiting example, the non-standoff surfaces 44 may be positioned to not contact the anti-corrosive substance 20 disposed on the exterior surface 16 of the pipe 12, and thereby not scrape or rub the anti-corrosive substance 20 from the exterior surface 16 of the pipe 12 at the location of the non-standoff surfaces 44. The portion of exterior surface 16 having the anti-corrosive substance 20 not in contact with the insulation member 10(1) may be less susceptible to scraping and rubbing and thereby may better protect the exterior surface 16 of the pipe 12 from corrosion.

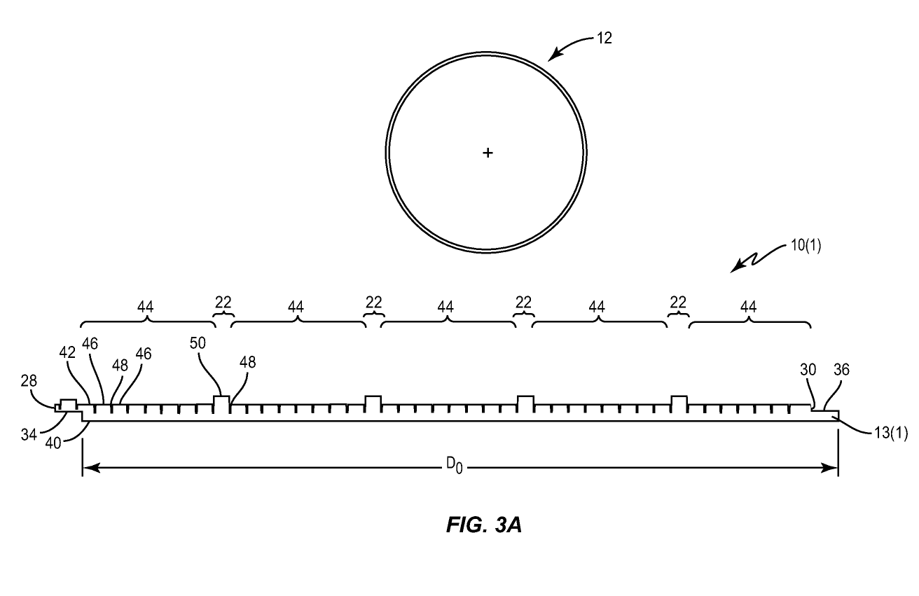

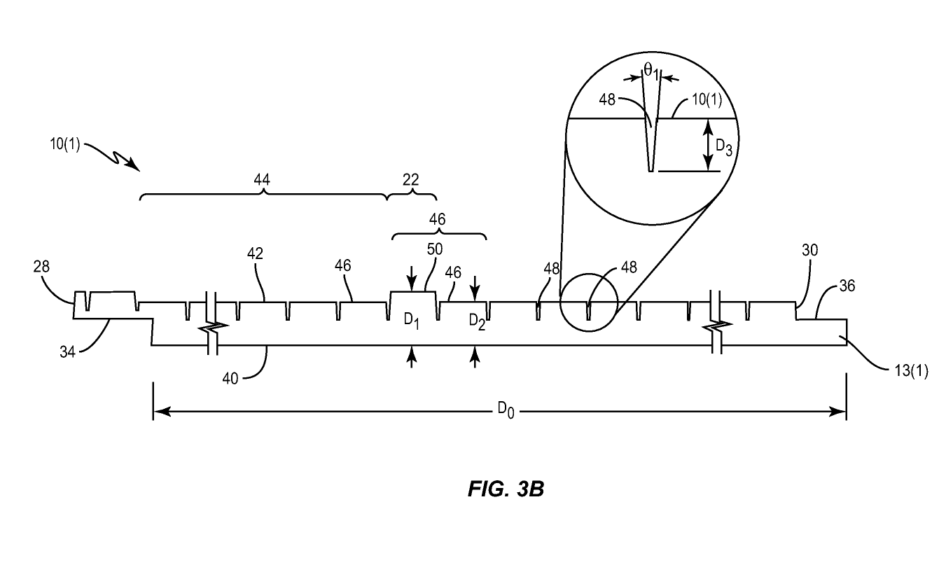

FIGS. 3A and 3B are side and close-up side views, respectively, of the insulation member 10(1) separated from the pipe 12. The insulation member 10(1) may be formed so that a distance D₀ is the circumference of the outer surface 40 when installed on the pipe 12. The inner surface 42 of the insulation member 10(1) may include segments 46 separated by grooves 48. The segments 46 may be foam segments. The grooves 48 may be, for example, V-shaped grooves including an angle θ₁ (theta 1). The grooves 48 may be cut from the extruded foam with, for example, a band saw. The angle θ₁ (theta 1) may be less than ninety (90) degrees. The grooves 48 may extend a distance D₃ into the insulation member 10(1) and may extend at least twenty-five (25) percent through the insulation member 10(1). The grooves 48 may or may not be equidistant from adjacent grooves 48. The grooves 48 permit the insulation member 10(1) to more easily wrap around the pipe 12 by reducing an amount of material located at the inner surface 42, which would resist bending.

The segments 46 include standoff segments 50 and non-standoff segments 52. The standoff segments 50 and non-standoff segments 52 may be foam standoff segments 50 and foam non-standoff segments 52, respectively. A maximum width D₁ of any of the standoff segments 50 may be greater than a maximum width D₂ of any of the non-standoff segments 52. The maximum width D₁ may be made thicker by cutting the non-standoff segments 52 with, for example, a band saw. The maximum width for any segment 46 may be measured as a distance measured orthogonal to the outer surface 40 of the insulation member 10(1), as shown in FIG. 3B. A difference in the maximum width D₁ and the maximum width D₂ enables the standoff surfaces 22 to abut against the pipe 12 and yet the non-standoff surfaces 44 to be free of contact with the pipe 12 and the anti-corrosive substance 20. The standoff surfaces 22 may include the standoff segments 50, and the non-standoff surfaces 44 may include the non-standoff segments 52.

FIG. 4A depicts the standoff surfaces 22 of the insulation member 10(1) being wrapped around the pipe 12. The grooves 48 may be aligned parallel to the longitudinal axis A₁ of the pipe 12 as the insulation member 10(1) is wrapped around the pipe 12. The standoff surfaces 22 nearest the first end surface 28 may be abutted first against the pipe 12. The remainder of the standoff surfaces 22 is then gradually placed in abutment with the pipe 12. Abutment between the standoff surfaces 22 and the pipe 12 may be completed when the shiplap connection 32 is attached by attaching the outward facing surface 34 and the inward facing surface 36 with the attachment means 38. FIG. 4B depicts a second insulation member 10(1) being wrapped around the pipe 12 and adjacent to the second side 26 of the first insulation member 10(1). Additional insulation members 10(1) may be attached to the pipe 12 adjacent to the first side 24 or the second side 26 of the pipe 12. It is noted that the insulation member 10(1) is not shown overlapping another of the insulation member 10(1), but overlap may be possible in some variants.

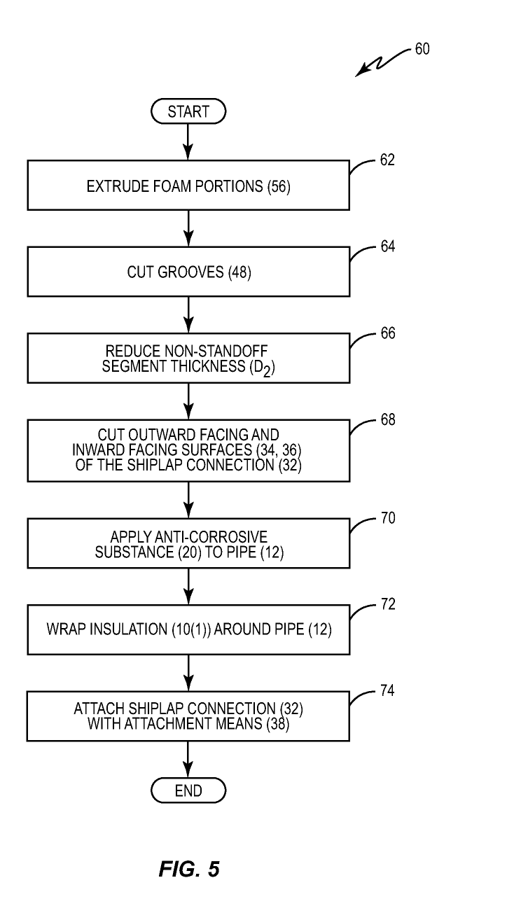

FIG. 5 provides an exemplary process 60 for manufacturing the insulation member 10(1) and attaching the insulation member 10(1) to the pipe 12. The process in FIG. 5 will be described using the terminology and information provided above. The first step in the process may be to extrude foam, for example, polyethylene foam (block 62 in FIG. 5). Next, the grooves 48 may be cut with, for example, a band saw (block 64 in FIG. 5). Next, the maximum thickness D₂ of the non-standoff segments 52 may be reduced with a material removal operation, for example, cutting with a band saw (block 66 in FIG. 5). Next, the outward facing surface 34 and the inward facing surface 36 of the shiplap connection 32 may be cut with, for example, a band saw (block 68 in FIG. 5). Next, the anti-corrosive substance 20 may be applied to the exterior surface 16 of the pipe 12 (block 70 in FIG. 5). The application may include merely painting the anti-corrosive substance 20 to the exterior surface 16 of the pipe 12.

Next, the insulation member 10(1) may be wrapped around the pipe 12 as shown earlier in FIG. 4A (block 72 in FIG. 5). First, the standoff surfaces 22 nearest the first end surface 28 may be abutted against the pipe 12. The remainder of the standoff surfaces 22 may then be gradually placed in abutment with the pipe 12. Next, the shiplap connection 32 may be attached (block 74 in FIG. 5). Specifically, the outward facing surface 34 and the inward facing surface 36 may be attached with the attachment means 38.

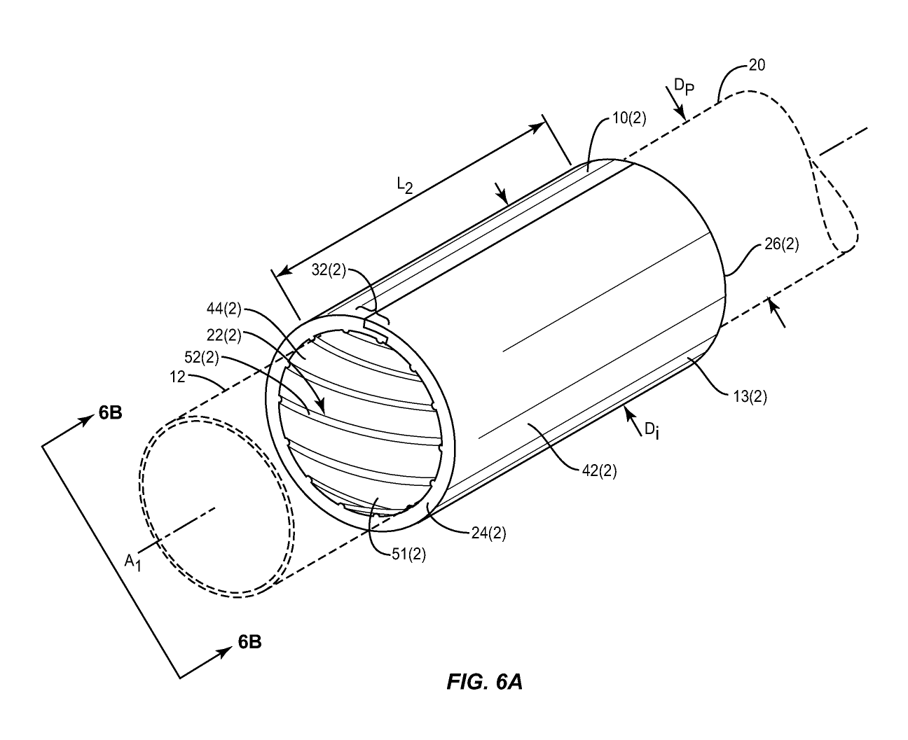

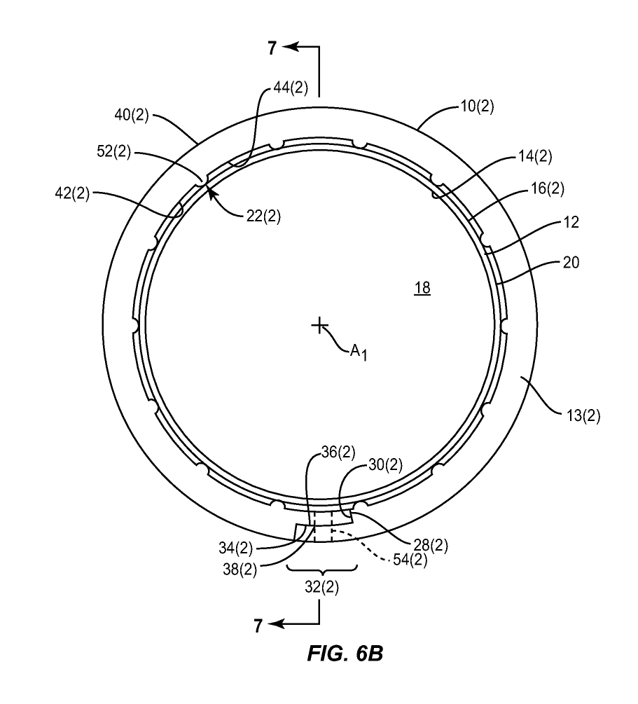

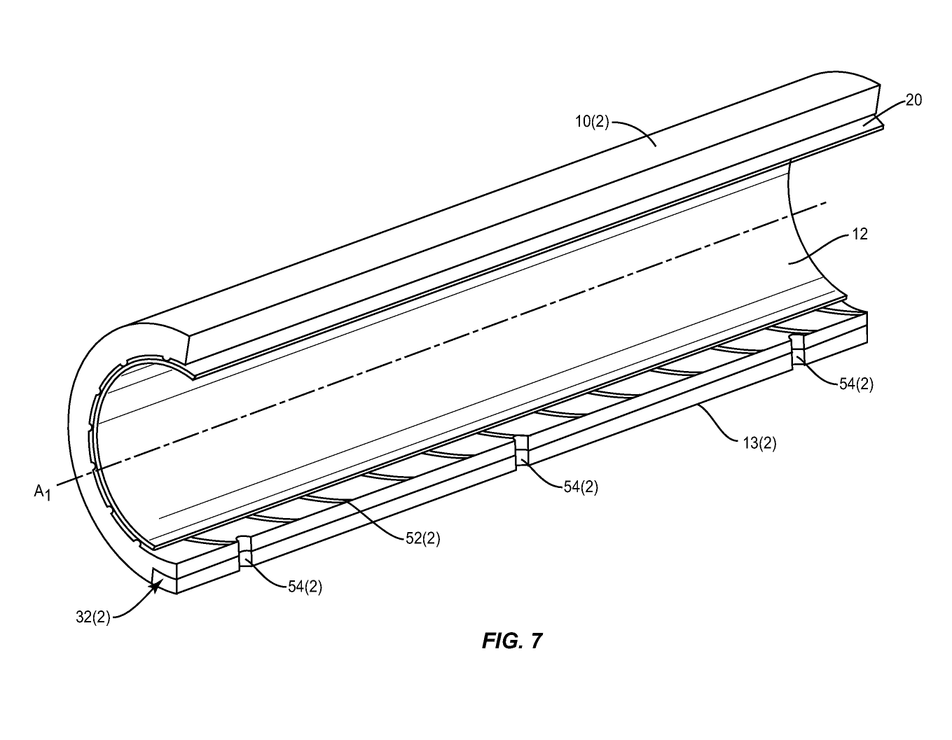

FIGS. 6A and 6B are perspective and longitudinal side views, respectively of an insulation member 10(2) which is a second exemplary embodiment of an insulation member employing standoff surfaces for insulating pipes. The insulation member 10(2) is shown attached to and insulating the pipe 12. The insulation member 10(2) may made from an elongated foam insulating body 13(1) of length L₂ and may be configured to be wrapped around the length L₂ of the pipe 12. The insulation member 10(2) may include a first side 24(2) and a second side 26(2). The insulation member 10(2) may also include the first end surface 28(2) and the second end surface 30(2). The first end surface 28(2) and second end surface 30(2) may be attached by the shiplap connection 32(2). The shiplap connection 32(2) may include the outward facing surface 34(2) and the inward facing surface 36(2) which may be attached by attachment means 38(2). As discussed earlier, the pipe 12 may have an anti-corrosive substance 20 applied to prevent corrosion of the exterior surface 16(2) of the pipe 12. As shown in FIG. 6B, the insulation member 10(2) may also include at least one drain hole 54(2), to be discussed later with FIG. 7.

The insulation member 10(2) may be made of a resilient material which does not allow moisture to pass; for example, extruded polyethylene foam. The insulation member 10(2) may contain an outer surface 40(2) and an inner surface 42(2). The inner surface 42(2) may be configured to face the pipe 12. The outer surface 40(2) may face away from the pipe 12 and may be opposite the inner surface 42(2).

This description will focus on the differences from the insulation member 10(1) in order to reduce redundancy. Unlike the previous embodiment, the insulation member 10(2) includes at least one helical rib 53 as part of an inner surface 42(2) of the insulation member 10(2). The helical rib 53 abuts against the exterior surface 16(2) of the pipe 12 and the remainder of the inner surface 42(2) of the insulation member 10(2) is free from contact against the pipe 12.

FIG. 7 depicts a perspective cutaway view showing the at least one helical rib 53 abutting against the exterior surface 16(2) of the pipe 12 in several locations along the longitudinal axis A₁ of the pipe 12. The insulation member 10(2) may also include the at least one drain hole 54(2) to drain fluid that may be disposed between the pipe 12 and the insulation member 10(2). Fluid and associated moisture may cause corrosion on the exterior surface 16(2) of the pipe 12. There may be, as shown in FIG. 7 for example, three of the at least one drain holes 54(2) in the insulation member 10(2).

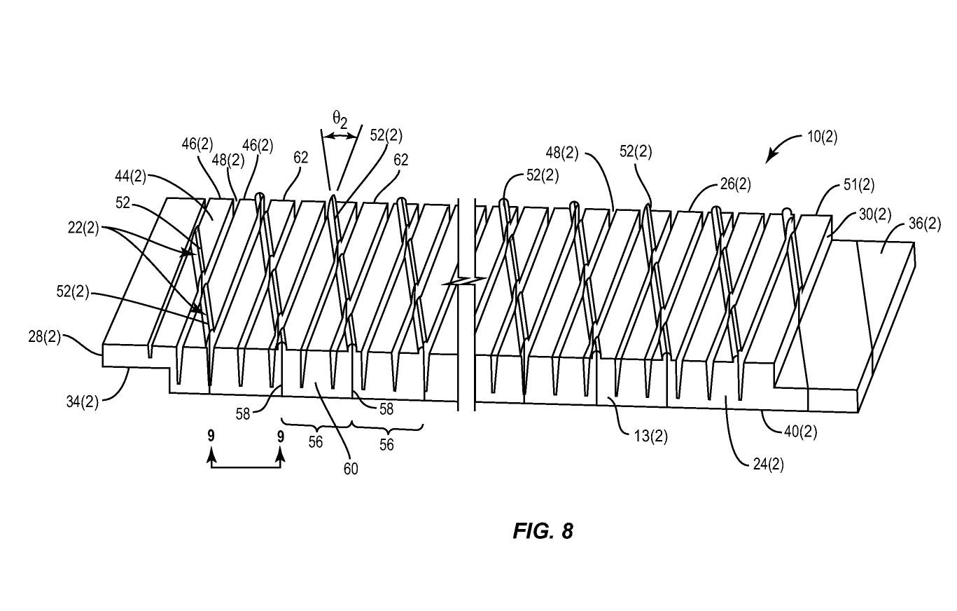

FIG. 8 shows a perspective view of the insulation member 10(2) unattached to the pipe 12 and in an elongated position to better show details of the inner surface 42(2). The inner surface 42(2) of the insulation member 10(2) may include segments 46(2) separated by grooves 48(2). Each of the segments 46(2) may include at least one standoff surface 22(2) configured to abut against the exterior surface 16(2) of the pipe 12. Each of the segments 46(2) may also include at least one non-standoff surface 44(2) configured to be free of contact with the exterior surface 16(2) of the pipe 12.

The standoff surfaces 22(2) may be the at least one helical rib 53. The at least one helical rib 53 may be integral to at least one of the segments 46(2). Each of the helical ribs 53 may be at an angle θ₂ (theta 2) to the grooves 48(2). The angle θ₂ (theta 2) may be at least zero (0) degrees and at most ninety (90) degrees. The angle θ₂ (theta 2) may be for example, thirty (30) degrees as shown in FIG. 8. When angle θ₂ (theta 2) is near zero (0), the insulation member 10(2) provides a structural connection to the pipe 12 similar to the insulation member 10(1); however, when water and/or various forms of moisture are disposed between the insulation 10(2) it is difficult to drain. When the angle θ₂ (theta 2) is near ninety (90) degrees, air ventilation between the insulation member 10(2) and the pipe 12 is restricted along the longitudinal axis A₁ of the pipe 12. An angle θ₂ (theta 2) of approximately thirty (30) degrees may allow air ventilation in a helical orientation around the pipe 12 and satisfactory drainage through the at least one drain hole 54 of water vapor and/or fluid.

The non-standoff surfaces 44(2) may be positioned to not contact the anti-corrosive substance 20 and thereby not scrape or rub the anti-corrosive substance 20 from the exterior surface 16(2) of the pipe 12. The exterior surface 16(2) may be better protected from corrosion when the anti-corrosive substance 20 is not rubbed or scraped.

With continuing reference to FIG. 8, the insulation member 10(2) may comprise foam portions 56 which may be extruded individually and include a portion of the helical ribs 53 as shown by weld lines 57. A side 58 and the other side 62 of the foam portions 56 may be cut, for example, with a band saw. These foam portions 56 may be welded together at the weld lines 57 and the grooves 48 may be cut later with, for example, a band saw. The side 58 and the other side 62 may have been cut so that after welding, the sides 58 of the foam portions 56 form the first side 24(2) in a planar shape and the other sides 59 of the foam portions 56 form the second side 26(2) in a planar shape.

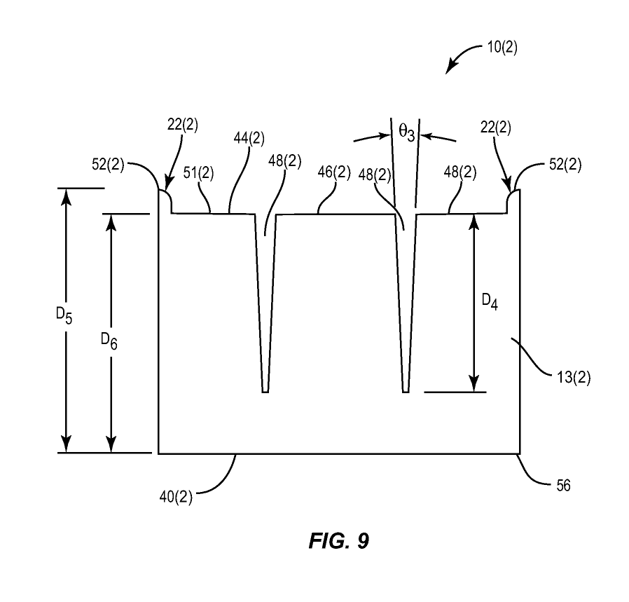

As shown in FIG. 9, the grooves 48(2) may be described the same way as those in FIG. 3B. The grooves 48(2) may be, for example, V-shaped grooves including an angle θ₃ (theta 3). The grooves 48(2) may be cut from the extruded foam with, for example, a band saw. The grooves 48(2) may extend a distance D₄ into the insulation member 10(2) and may extend at least twenty-five (25) percent through the insulation member 10(2). The grooves 48(2) may or may not be equidistant from adjacent grooves 48(2). The grooves 48(2) permit the insulation member 10(2) to more easily wrap around the pipe 12 by reducing an amount of material located at the inner surface 42(2) which would resist bending.

A maximum width D₅ of any of the standoff surfaces 22(2) may be greater than a maximum width D₆ of any of the non-standoff surfaces 44(2). The maximum width D₅ may be greater because the non-standoff surfaces 44(2) may be extruded with these dimensional features. The maximum width for any segment 46(2) may be measured as a distance measured orthogonal to the outer surface 40(2) of the insulation member 10(2) as shown in FIG. 9. A difference in the maximum width D₅ and the maximum width D₆ enables the standoff surface 22(2) to abut against the pipe 12 and yet the non-standoff surfaces 44(2) may be free of contact with the pipe 12 and the anti-corrosive substance 20. The standoff surfaces 22(2) may include the helical ribs 53 as discussed earlier.

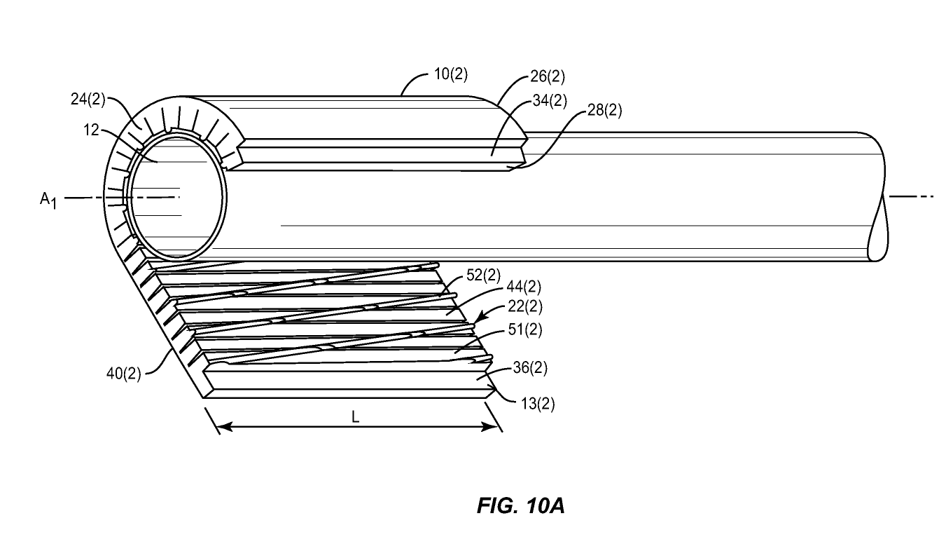

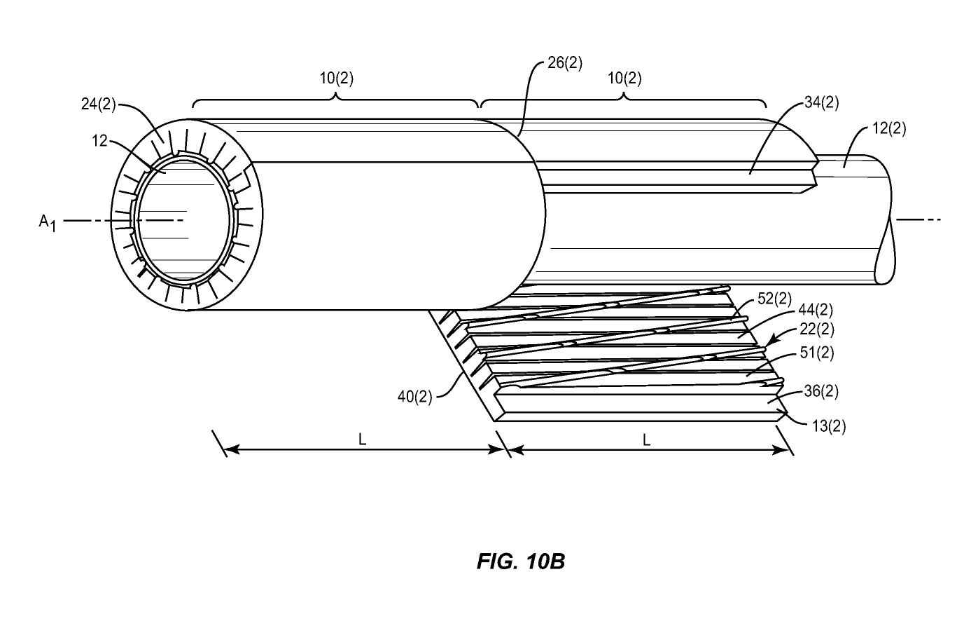

FIG. 10A depicts the standoff surfaces 22(2) comprising the helical rib 53 of the insulation member 10(2) being wrapped around the pipe 12. The grooves 48(2) may be aligned parallel to the longitudinal axis A₁ of the pipe 12 as the insulation member 10(2) is wrapped around the pipe 12 to enable a bending of the insulation member 10(2) at the grooves 48(2) to match a radius of curvature of the pipe 12. The standoff surfaces 22(2) nearest the first end surface 28(2) may be abutted against the pipe 12 first, then a remainder of the standoff surfaces 22(2) is gradually placed in abutment with the pipe 12. Abutment between the standoff surfaces 22(2) and the pipe 12 may be completed when the shiplap connection 32(2) may be attached by attaching the outward facing surface 34(2) and the inward facing surface 36(2) with the attachment means 38(2).

FIG. 10B depicts another insulation member 10(2) being wrapped around the pipe 12 and adjacent to the second side 26(2) of the insulation member 10(2). Additional quantities of the insulation members 10(2) may be attached to the pipe 12 adjacent to the first side 24(2) or the second side 26(2). It is noted that the insulation members 10(2) are not shown overlapping another of the insulation member 10(2), but overlap may be possible.

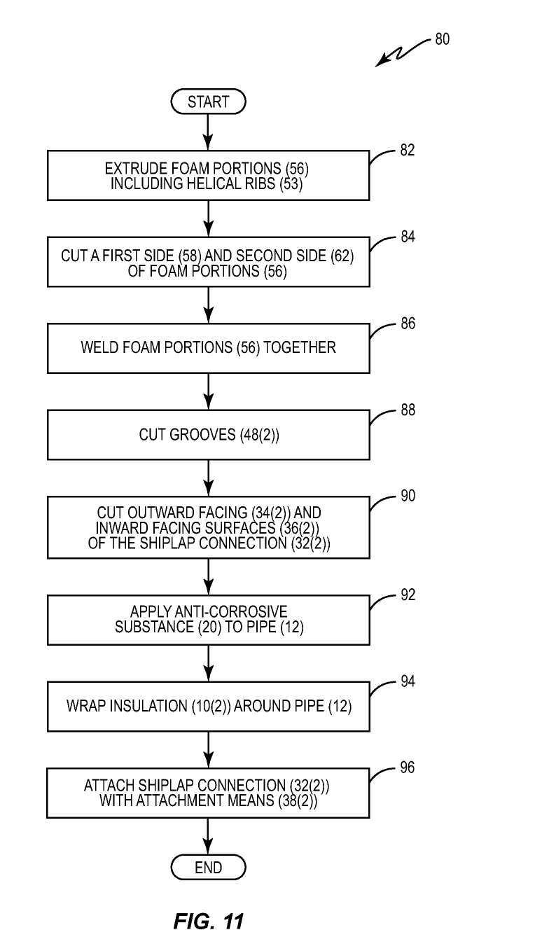

FIG. 11 provides an exemplary process 80 for manufacturing the insulation member 10(2) and attaching the insulation member 10(2) to the pipe 12. The process 80 in FIG. 11 will be described using the terminology and information provided above. The first step in the process may be to extrude the foam portions 56 including at least a portion of the helical ribs 53 (block 82 in FIG. 11). Next, the side 58 and the other side 62 of the foam portions 56 may be cut, for example, with a band saw (block 84 in FIG. 11). Next, the foam portions 56 may be welded together (block 86 in FIG. 11). Next, the grooves 48(2) may be cut with, for example, a band saw (block 88 in FIG. 11). Next, the outward facing surface 34(2) and the inward facing surface 36(2) of the shiplap connection 32(2) may be cut with, for example, a band saw (block 90 in FIG. 11). Next, the anti-corrosive substance 20 may be applied to the exterior surface 16(2) of the pipe 12 (block 92 in FIG. 11). The application may include merely painting the anti-corrosive substance 20 to the exterior surface 16(2) of the pipe 12.

Next, as shown previously in FIG. 10A, the insulation member 10(2) may be wrapped around the pipe 12 (block 94 in FIG. 11). First, the standoff surfaces 22(2) nearest the first end surface 28(2) may be abutted against the pipe 12. Then the remainder of the standoff surfaces 22(2) is gradually placed in abutment with the pipe 12. Next, the shiplap connection 32(2) may be attached (block 96 in FIG. 11). Specifically, the outward facing surface 34(2) and the inward facing surface 36(2) may be attached with the attachment means 38(2).

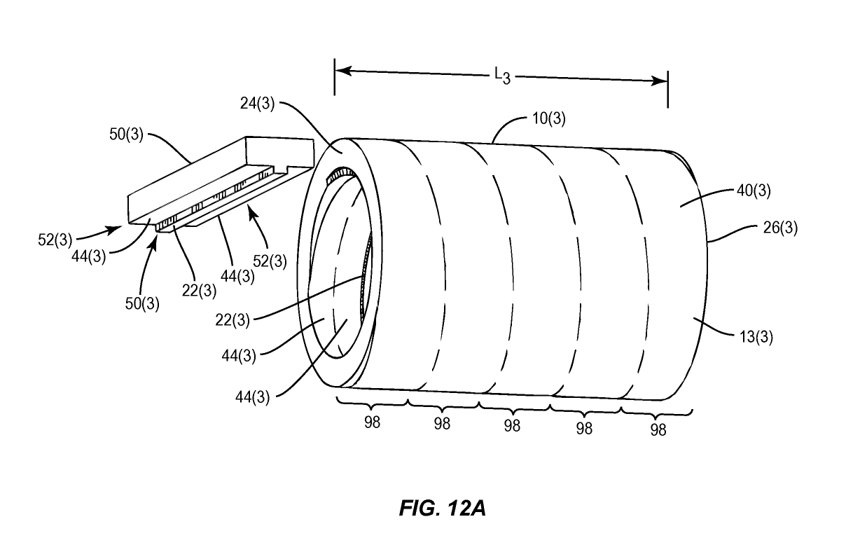

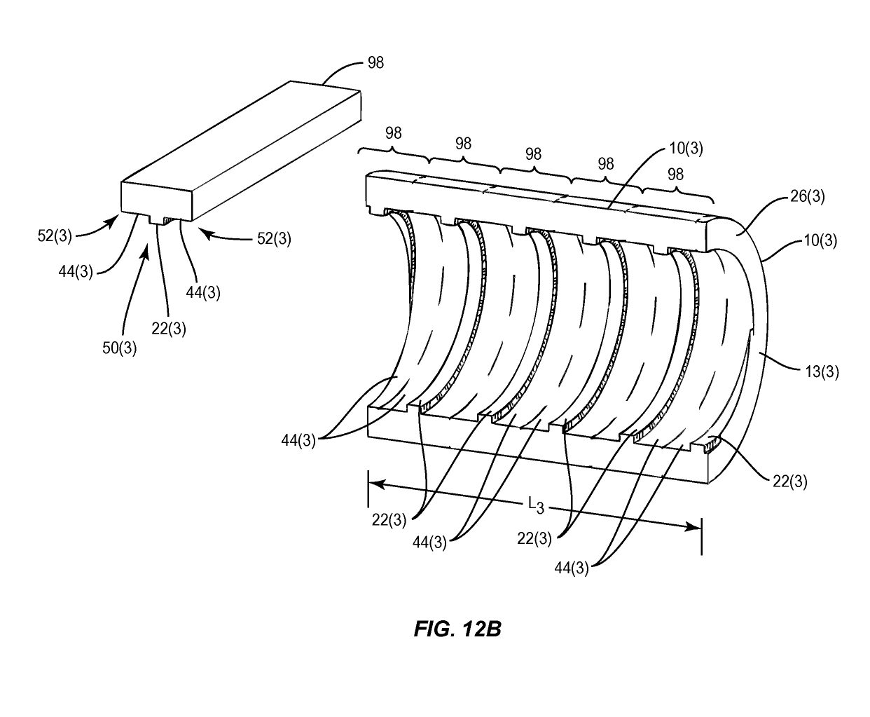

Other forms of insulating members employing standoff members for insulating a pipe, such as pipe 12, may also be provided. In this regard, FIGS. 12A and 12B are side and side cross-sectional perspective views, respectively, of a third exemplary insulation member 10(3) employing standoff surfaces for insulating a pipe. The insulation member 10(3) in FIGS. 12A and 12B is not shown insulating a pipe, but can be employed to insulate any pipe, including pipe 12 previous described above. In this embodiment, the insulation member 10(3) is a spiral-formed insulation member formed from a foam insulating body 13(3), as will be described in more detail below. With continuing reference to FIGS. 12A and 12B, the insulation member 10(3) may contain an outer surface 40(3) and an inner surface 42(3). The inner surface 42(3) may be configured to face a pipe. The outer surface 40(3) may face away from an insulated pipe and is opposite the inner surface 42(3).

With continuing reference to FIGS. 12A and 12B, the insulation member 10(3) is of length L₃. The insulation member 10(3) may be made of a resilient material which does not allow moisture to pass; for example, extruded polyethylene foam. The insulation member 10(3) may include a first side 24(3) and a second side 26(3). The insulation member 10(3) may also include the end surface 28(3). Since the insulation member 10(3) is spiral formed, the end surface 28(3) is formed by cutting the spiral formed insulation member 10(3) to the desired length, which is length L₃. A shiplap connection attachment means is not required. The insulation member 10(3) may be installed on a pipe, such as pipe 12, that has an anti-corrosive substance applied to prevent corrosion of the exterior surface of the pipe.

With continuing reference to FIGS. 12A and 12B, the insulation member 10(3) is spiral formed from segments 98 of foam material that include standoff members 50(3) having standoff surfaces 22(3). The standoff members 50(3) are configured to provide the stand-off surfaces 22(3) to abut against an exterior surface of a pipe insulated with the insulation member 10(3). The standoff surfaces 22(3) may reduce disturbance of the anti-corrosive substance applied to an insulated pipe, as one non-limiting example. The segments 98 also include non-standoff segments 52(3) that include non-standoff surfaces 44(3). The non-standoff segments 52(3) are configured to provide the non-standoff surfaces 52(3) to be free of abutment to an exterior surface of a pipe insulated with the insulation member 10(3). The non-standoff surfaces 44(3) may be positioned to not contact an anti-corrosive substance disposed on an exterior surface of an insulated pipe, and thereby not scrape or rub the anti-corrosive substance on the exterior surface of the pipe at the location of the non-standoff surfaces 44(3). The portion of exterior surface of a pipe having the anti-corrosive substance not in contact with the insulation member 10(3) may be less susceptible to scraping and rubbing and thereby may better protect the exterior surface of a pipe insulated by insulation member 10(3) from corrosion.

The segments 98 may be extruded or cut. The segments 98 are provided wherein the standoff members 50(3) having standoff surfaces 22(3) and non-standoff members 52(3) having standoff surfaces 44(3) are formed by extrusion or cuts of the segment 98 in this embodiment. However, the standoff members 50(3) could also be attached by adhesion or cohesion to the non-standoff members 52(3) to form the segments 98, if desired.

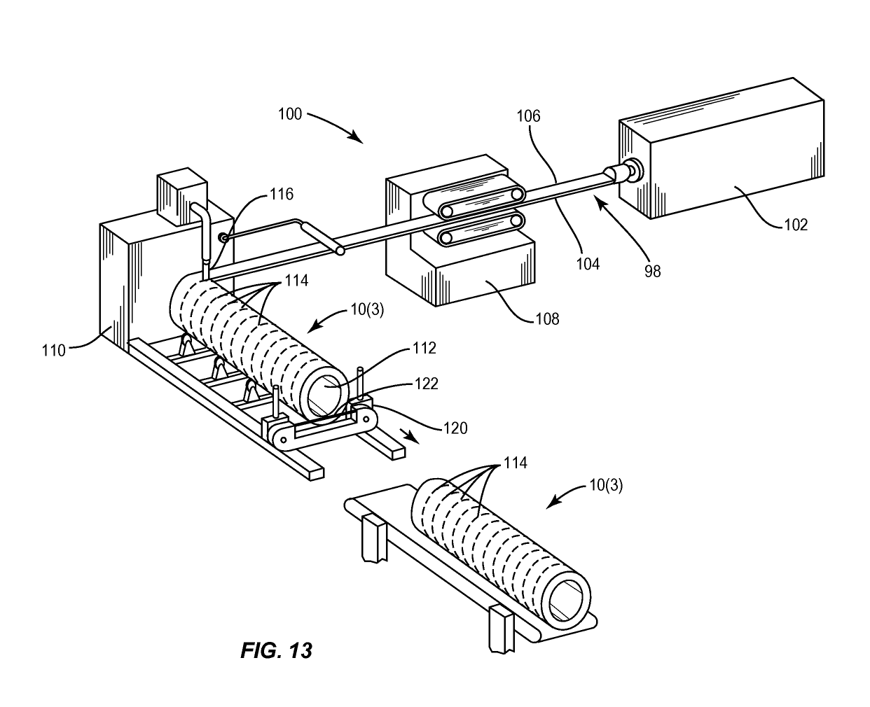

The insulation member 10(3) may include any of the spiral formed insulation members in U.S. Provisional Patent Application Ser. No. 61/646,049 filed on May 11, 2012, incorporated herein by reference in its entirety. The insulation member 10(3) may be formed using any of the spiral-forming methods provided in U.S. Provisional Patent Application Ser. No. 61/646,049. For example, FIG. 13 shows an exemplary product forming system 100 in the prior art for forming the insulation member 18(3). In this embodiment, product forming system 100 comprises an extruder 102 having a generally conventional configuration which produces the foamed segments 98 in any desired configuration having side edges 104 and 106. Puller 108 may be employed for continuously drawing the foamed polyolefin segment 98 from extruder 102 and feeding the foamed polyolefin segments 98 to tube forming machine 110. In employing the product forming system 100, any polyolefin material may be used to form the foamed polyolefin segments 98. However the preferred polyolefin material comprises one or more selected from the group consisting of polystyrenes, polyolefins, polyethylenes, polybutanes, polybutylenes, polyurethanes, thermoplastic elastomers, thermoplastic polyesters, thermoplastic polyurethanes, polyesters, ethylene acrylic copolymers, ethylene vinyl acetate copolymers, ethylene methyl acrylate copolymers, ethylene butyl acrylate copolymers, ionomers polypropylenes, and copolymers of polypropylene.

The tube forming machine 110 is constructed for receiving the foam polyolefin segments 98 on continuously rotating mandrel 112 in a manner which causes segments 98 to be wrapped around the rotating mandrel 112 of tube forming machine 110 continuously, forming a plurality of spirally wound convolutions 114 in a side-to-side abutting relationship. In this way, the incoming continuous feed of the foamed polyolefin segments 98 may be automatically rotated about mandrel 112 in a generally spiral configuration, causing side edge 104 of the foam polyolefin segments 98 to be brought into abutting contact with the side edge 106 of previously received and wrapped convolution 112. By bonding side edges 104 and 106 to each other at this juncture point, the insulation member 18(3) may be formed substantially cylindrical and hollow. In order to provide integral bonded engagement of side edge 104 of the foam polyolefin segments 98 with the side edge 106 of convolution 114, a bonding or fusion head 116 may be employed. If desired, the bonding fusion head 116 may comprise a variety of alternate constructions in order to attain the desired secure affixed bonded inter-engagement of the edge 104 with the edge 106. In the preferred embodiment, the bonding fusion head 116 employs heated air.

By delivering heated air to head 116, a temperature of the head 116 is elevated to a level which enables the side edges 104, 106 of segments 98 and convolution 114 which contacts head 116 to be raised to their melting point and may be securely fused or bonded to each other. The bonding fusion head 116 may be positioned at the juncture zone at which side edge 104 of the segments 98 is brought into contact with the side edge 106 of the previously received and spiral wrapped convolution 114. By causing the bonding fusion head 116 to simultaneously contact side edge 104 and the side edge 106 of these components of segments 98, the temperature of the surfaces is raised to the melting point thereof, thus enabling the contact of the side edge 68 of incoming segments 98 to be brought in direct contact with side edge 106 of first spiral wrapped convolution 114 in a manner which causes the surfaces to be intimately bonded to each other. Although heated air is preferred for this bonding operation, alternate affixation means may be employed. One such alternative is the use of heated adhesives applied directly to the side edges 104, 106. A cutting system 120 including a heated wire 122 may cut the insulation member 18(3) perpendicular to the center axis of the mandrel 112. In this manner, the insulation member 18(3) may be created.

Many modifications and other variations of the embodiments disclosed herein will come to mind to one skilled in the art to which the embodiments pertain having the benefit of the teachings presented in the foregoing descriptions and the associated drawings. Therefore, it is to be understood that the description and claims are not to be limited to the specific embodiments disclosed and that modifications and other embodiments are intended to be included within the scope of the appended claims. It is intended that the embodiments cover the modifications and variations of the embodiments provided they come within the scope of the appended claims and their equivalents. Although specific terms are employed herein, they are used in a generic and descriptive sense only and not for purposes of limitation.

We claim:

1. An insulation member for a pipe, comprising:
a foam insulation body comprised of at least one foam portion, the foam insulation body configured to be disposed around a pipe, the foam insulation body comprising at least one foam portion comprising:
an inner surface configured to face the pipe; and
an outer surface opposite the inner surface, the inner surface including at least one foam segment;
the at least one foam segment comprising at least one standoff segment configured to abut against the pipe and at least one non-standoff segment configured to be free from abutment against the pipe when the foam insulation body is disposed around the pipe.

2. The insulation member of claim 1, wherein the at least one standoff segment is disposed integral with the inner surface of the foam insulation body.

3. The insulation member of claim 1, wherein a maximum thickness of the at least one standoff segment is greater than a maximum thickness of the at least one non-standoff segment.

4. The insulation member of claim 1, wherein the at least one foam segment is comprised of a plurality of foam segments, and is further comprised of at least one groove disposed on the inner surface of the foam insulation body separating the plurality of foam segments.

5. The insulation member of claim 4, wherein the at least one groove is comprised of at least one angled groove.

6. The insulation member of claim 4, wherein the at least one groove is cut into the inner surface of the foam insulation member.

7. The insulation member of claim 1, further comprising at least one helical rib disposed in the inner surface of the foam insulation body, the at least one helical rib traversing the at least one standoff segment.

8. The insulation member of claim 7, wherein the at least one helical rib is disposed integral with the inner surface of the foam insulation body.

9. The insulation member of claim 1, wherein the at least one foam portion is comprised of at least one spirally formed foam portion.

10. The insulation member of claim 9, wherein the at least one standoff segment is comprised of at least one spirally formed standoff segment in the inner surface of the foam insulation body.

11. The insulation member of claim 10, wherein the at least one spirally formed standoff segment is formed by an extrusion of the at least one foam portion.

12. The insulation member of claim 1, wherein the foam insulation member comprises a first end surface and a second end surface, the first end surface secured to the second end surface to provide for the foam insulation body to be disposed around the pipe.

13. The insulation member of claim 12, further comprising a shiplap connection connecting the first end surface of the foam insulation body to the second end surface of the foam insulation body.

14. The insulation member of claim 1 comprising a plurality of the foam insulation members configured to be disposed adjacent to each other around the pipe.

15. The insulation member of claim 1, wherein the foam insulation body is comprised of a plurality of foam portions attached to each other.

16. A method of forming an insulation member for a pipe, comprising:
extruding at least one foam portion comprising an outer surface and an inner surface configured to face a pipe to form a foam insulation body, the inner surface including at least one foam segment, the at least one foam segment each comprising at least one standoff segment configured to abut against the pipe and at least one non-standoff segment configured to be free from abutment against the pipe when the foam insulation body is disposed around the pipe;
cutting a first side of the foam insulation body;
cutting a second side of the foam insulation body, the second side opposite the first side;
disposing the foam insulation body around the pipe such that the at least one standoff segment abuts against an exterior surface of the pipe, and the at least one non-standoff segment is free from abutment against the exterior surface of the pipe;
securing the first side of the foam insulation body to the second side of the foam insulation body to secure the foam insulation body to the pipe.

17. The method of claim 16, further comprising applying an anti-corrosive substance to at least a portion of the exterior surface of the pipe before disposing the foam insulation body around the pipe, and securing the first side of the at least one foam portion to the second side of the at least one foam portion.

18. The method of claim 16, comprising:
extruding a plurality of the at least one foam portions; and
securing the plurality of foam portions together to form the foam insulation body.

19. The method of claim 18, wherein securing the plurality of foam portions together comprises welding the plurality of foam portions together to form the foam insulation body.

20. The method of claim 16, further comprising cutting at least one groove in the inner surface of the foam insulation body.

21. The method of claim 16, further comprising cutting at least one outward facing surface in the first side of the foam insulation body; and
cutting at least one inward facing surface in the second side of the foam insulation body to form a shiplap connection member in the foam insulation body;
wherein securing the first side of the foam insulation body to the second side of the foam insulation body comprises securing the at least one inward facing surface of the shiplap connection member to the at least one outward facing surface of the shiplap connection member to form a shiplap connection.

22. The method of claim 16, further comprising disposing the at least one standoff segment integral with the inner surface of the foam insulation body.

23. The method of claim 16, wherein the at least one foam segment is comprised of a plurality of foam segments, and further comprising disposing at least one groove in the inner surface of the foam insulation body separating the plurality of foam segments.

24. The method of claim 23, wherein disposing the at least one groove in the inner surface of the foam insulation body comprises cutting the at least one groove into the inner surface of the foam insulation member.

25. The method of claim 16, further comprising disposing at least one helical rib in the inner surface of the foam insulation body, the at least one helical rib traversing the at least one standoff segment.

26. The method of claim 16, further comprising spirally forming the extruded at least one foam portion to form the foam insulation body.
